(19) United States
(12) Patent Application Publication
(10) Pub. No.: US 2026/0329410 A1
(43) Pub. Date: Oct. 22, 2026

(54) CURSOR SWITCHING SYSTEM AND CURSOR SWITCHING METHOD THEREOF

(71) Applicant: QISDA CORPORATION, Taoyuan City (TW)

(72) Inventors: Yu-Fu Fan, Taoyuan City (TW); Yen-Lin Chou, Taoyuan City (TW); Chang-Cheng Chen, Miaoli County (TW)

(73) Assignee: QISDA CORPORATION, Taoyuan City (TW)

(21) Appl. No.: 19/647,909

(22) Filed: Apr. 15, 2026

(30) Foreign Application Priority Data
Apr. 22, 2025 (CN) 202510508842.6
Aug. 5, 2025 (CN) 202511091866.2

(51) Int. Cl. G06F 3/04812

(52) U.S. Cl. CPC G06F 3/04812; G06F 2203/04803

(57) ABSTRACT

A cursor switching system includes a display unit, first and second electronic units, and an operating unit. The display unit has a display screen including a first display area, a second display area, and a switching area. The first and second electronic units respectively display a first image in the first display area and a second image in the second display area. The operating unit is presented by a cursor operable on the display screen. The cursor has a first parameter setting in the first image and a second parameter setting in the second image. When the cursor moves from the first display area until the cursor at least partially contacts the switching area and the cursor stays in the switching area for a predetermined time before moving to the second display area, the cursor switches from the second parameter setting to the first parameter setting in the second image.

### BACKGROUND OF THE INVENTION

### 1. Field of the Invention

The present invention relates to a cursor switching system and a cursor switching method thereof, and more specifically, to a cursor switching system for moving a cursor on a display screen and a cursor switching method thereof.

### 2. Description of the Prior Art

In PBP (Picture-by-Picture)/PIP (Picture-in-Picture) modes of conventional display monitors, if image resolutions of multiple computers are different from each other, significant displacement of a cursor occurs when the cursor crosses a boundary between adjacent images, thereby affecting the user experience. Furthermore, cursor parameter settings (e.g., cursor speed or acceleration) of computers are usually different from each other. As such, when the cursor moves between different PBP/PIP display areas, inconsistent speed and behavior of the cursor result in operational inconvenience.

Therefore, it is necessary to design a novel cursor switching system and a cursor switching method thereof to overcome the aforementioned problems.

### SUMMARY OF THE INVENTION

One purpose of the present invention is to provide a cursor switching system and a cursor switching method thereof for achieving consistent speed and behavior of a cursor when moving between different display areas simply by monitoring whether the cursor moves and stays in a switching area for cursor parameter switching.

For achieving the aforesaid purpose, the present invention provides a cursor switching system including a display unit, a first electronic unit, a second electronic unit, and an operating unit. The display unit has a display screen, wherein the display screen includes a first display area, a second display area, and a switching area, and the switching area separates the first display area and the second display area. The first electronic unit is coupled to the display unit, wherein the first electronic unit displays a first image in the first display area. The second electronic unit is coupled to the display unit, wherein the second electronic unit displays a second image in the second display area. The operating unit is coupled to the display unit, wherein the operating unit is presented by a cursor on the display screen, and the cursor is operable on the display screen. The cursor has a first parameter setting in the first image, the cursor has a second parameter setting in the second image, and the first parameter setting is different from the second parameter setting. When the cursor moves from the first display area until the cursor at least partially contacts the switching area and then the cursor stays in the switching area for a duration greater than or equal to a predetermined time before moving to the second display area, the cursor switches from the second parameter setting to the first parameter setting in the second image to be operated according to the first parameter setting.

Preferably, the display screen further includes a first switching line located in the first display area, and a distance from the first switching line to a side of the switching area is a first distance. When the cursor crosses the first switching line until the cursor at least partially contacts the switching area and then the cursor stays in the switching area for the duration greater than or equal to the predetermined time before moving to the second display area, the cursor maintains the first parameter setting.

Preferably, the predetermined time is 1.5 seconds, and the first distance is 10 pixels.

Preferably, the cursor moves from the first display area to the switching area with a first trajectory and a first speed, and when the cursor switches from the first parameter setting to the second parameter setting, the cursor moves from the switching area to the second display area with the first trajectory and the first speed.

Preferably, the cursor switching system further includes a storage unit coupled to the operating unit, the operating unit controls the first electronic unit to send the first parameter setting to the storage unit, and the operating unit controls the second electronic unit to send the second parameter setting to the storage unit. When the cursor moves from the first display area until the cursor at least partially contacts the switching area, the first trajectory and the first speed of the cursor are stored in the storage unit, and the cursor then moves from the switching area to the second display area with the first trajectory and the first speed.

Preferably, the storage unit is a USB hub.

The present invention further provides a cursor switching method applied to a cursor switching system. The cursor switching system includes a display unit, a first electronic unit, a second electronic unit, and an operating unit, the display unit is respectively coupled to the first electronic unit, the second electronic unit, and the operating unit, the display unit has a display screen including a first display area, a second display area, and a switching area, and the switching area separates the first display area and the second display area. The cursor switching method includes displaying a first image of the first electronic unit in the first display area, displaying a second image of the second electronic unit in the second display area, and presenting the operating unit by a cursor on the display screen, wherein the cursor is operable on the display screen. The cursor switching method further includes switching the cursor from a second parameter setting to a first parameter setting in the second image when the cursor moves from the first display area until the cursor at least partially contacts the switching area and then the cursor stays in the switching area for a duration greater than or equal to a predetermined time before moving to the second display area, wherein the cursor has the first parameter setting in the first image, the cursor has the second parameter setting in the second image, and the first parameter setting is different from the second parameter setting.

Preferably, the display screen further includes a first switching line located in the first display area, and a distance from the first switching line to a side of the switching area is a first distance. When the cursor crosses the first switching line until the cursor at least partially contacts the switching area and then the cursor stays in the switching area for the duration greater than or equal to the predetermined time before moving to the second display area, the cursor maintains the first parameter setting. When the cursor moves from the first display area until the cursor at least partially contacts the switching area and then the cursor stays in the switching area for a duration less than the predetermined time before moving to the second display area, the cursor retains the first parameter setting.

Preferably, the cursor switching system further includes a storage unit, and the cursor switching method further includes coupling the storage unit to the operating unit, controlling the first electronic unit to send the first parameter setting to the storage unit via the operating unit, controlling the second electronic unit to send the second parameter setting to the storage unit via the operating unit, storing the first trajectory and the first speed of the cursor in the storage unit when the cursor moves from the first display area until the cursor at least partially contacts the switching area, and moving the cursor with the first trajectory and the first speed when the cursor moves from the switching area to the second display area.

Compared with the prior art, the present invention provides the cursor switching system and the cursor switching method thereof. The cursor switching system includes the display unit, the first electronic unit, the second electronic unit, and the operating unit. The display unit has the display screen, and the display screen includes the first display area, the second display area, and the switching area. The switching area separates the first display area and the second display area. The first electronic unit is coupled to the display unit, and the first electronic unit displays the first image in the first display area. The second electronic unit is coupled to the display unit, and the second electronic unit displays the second image in the second display area. The operating unit is coupled to the display unit, and the operating unit is presented by the cursor on the display screen. The cursor is operable on the display screen. The cursor has the first parameter setting in the first image, and the cursor has the second parameter setting in the second image, wherein the first parameter setting is different from the second parameter setting. When the cursor moves from the first display area until the cursor at least partially contacts the switching area, and the cursor stays in the switching area for the predetermined time before moving to the second display area, the cursor switches from the first parameter setting to the second parameter setting. That is, the second parameter setting is replaced by the first parameter setting after the cursor moves to the second image, so that the cursor is operable in the second image according to the first parameter setting. In such a manner, consistent speed and behavior of the cursor when moving between different display areas can be achieved simply by monitoring whether the cursor moves to and stays in the switching area for cursor parameter switching.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a cursor switching system according to an embodiment of the present invention.

FIG. 2 is a diagram of a cursor moving from a first display area to a switching area according to an embodiment of the present invention.

FIG. 3 is a diagram of the cursor moving from the switching area to a second display area according to an embodiment of the present invention.

FIG. 4 is a diagram of the cursor crossing a first switching line according to an embodiment of the present invention.

FIG. 5 is a diagram of a display screen according to another embodiment of the present invention.

FIG. 6 is a flowchart of a cursor switching method according to an embodiment of the present invention.

### DETAILED DESCRIPTION

To facilitate a further understanding of the objectives, structures, features, and functions of the present invention, a detailed description is provided as follows with the embodiments.

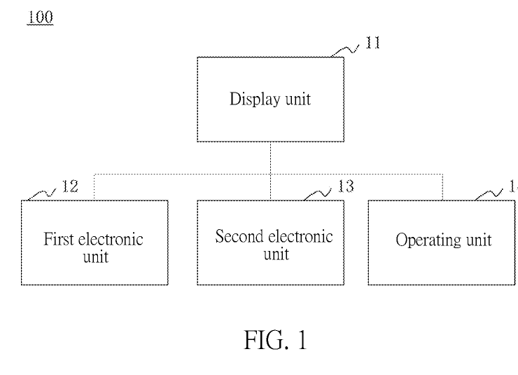

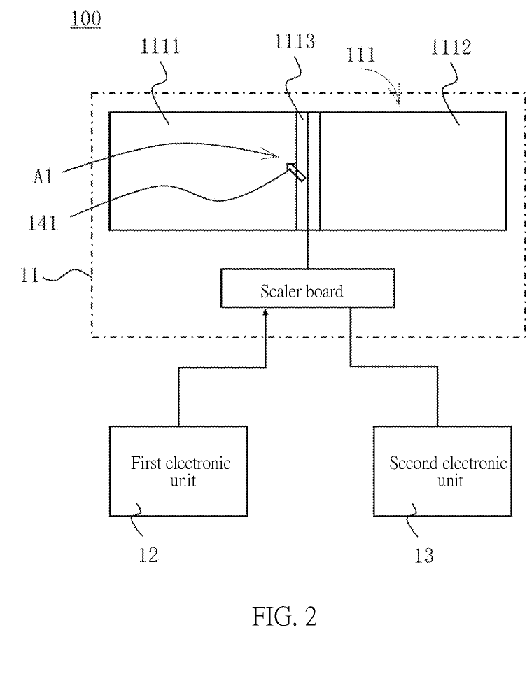

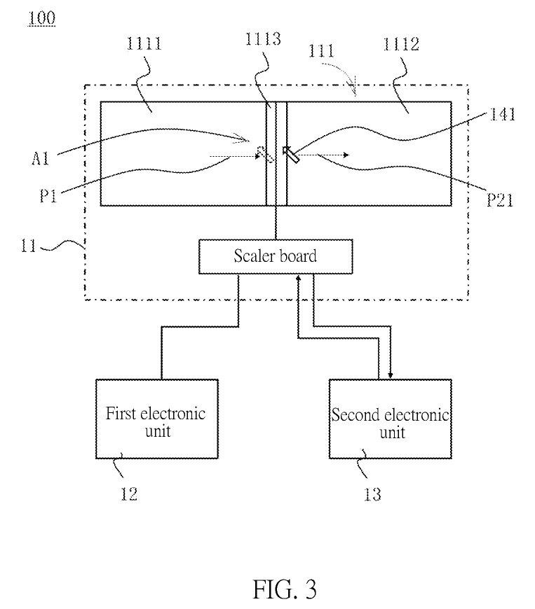

Please refer to FIGS. 1, 2 and 3, is a functional block diagram of a cursor switching system according to an embodiment of the present invention. FIG. 2 is a diagram of a cursor moving from a first display area to a switching area according to an embodiment of the present invention. FIG. 3 is a diagram of the cursor moving from the switching area to a second display area according to an embodiment of the present invention. The present invention provides a cursor switching system 100 for switching a cursor between display areas. The cursor switching system 100 includes a display unit 11, a first electronic unit 12, a second electronic unit 13, and an operating unit 14. The display unit 11 has a display screen 111. The display screen 111 includes a first display area 1111, a second display area 1112, and a switching area 1113. The switching area 1113 separates the first display area 1111 and the second display area 1112. The first electronic unit 12 is coupled to the display unit 11, and the first electronic unit 12 displays a first image in the first display area 1111. The second electronic unit 13 is coupled to the display unit 11, and the second electronic unit 13 displays a second image in the second display area 1112. The operating unit 14 is coupled to the display unit 11. The operating unit 14 is presented by a cursor 141 on the display screen 111, and the cursor 141 is operable on the display screen 111. The cursor 141 has a first parameter setting in the first image, and the cursor 141 has a second parameter setting in the second image. The first parameter setting is different from the second parameter setting. When the cursor 141 moves from the first display area 1111 until the cursor 141 at least partially contacts the switching area 1113 and then the cursor 141 stays in the switching area 1113 for a predetermined time before moving to the second display area 1112, the cursor 141 switches from the second parameter setting to the first parameter setting in the second image. In such a manner, consistent speed and behavior of the cursor when moving between different display areas can be achieved by monitoring whether the cursor moves to and stays in the switching area for cursor parameter switching.

Referring to FIGS. 1, 2 and 3, each of the first electronic unit 12 and the second electronic unit 13 could be a portable electronic device (e.g., a laptop, a tablet, or a mobile phone). The first electronic unit 12 and the second electronic unit 13 are respectively coupled to the display unit 11. The coupling method involves respectively coupling the first electronic unit 12 and the second electronic unit 13 to a connection port of the display unit 11 via HDMI (High Definition Multimedia Interface), VGA (Video Graphic Array), DP (Display Port), USB-C (USB Type-C), or other connection ports. Alternatively, the first electronic unit 12 and the second electronic unit 13 could be coupled to a connection port externally connected to the display unit 11 via HDMI, VGA, DP, USB-C, or other connection ports. As for which coupling method is adopted, it depends on the actual application of the cursor switching system of the present invention and is not limited thereto.

Referring to FIGS. 1, 2 and 3, the operating unit 14 could be a mouse externally connected to the display unit 11. The operating unit 14 could be coupled to a connection port of the display unit 11 via a wired or wireless connection method. As for which connection method is adopted, it depends on the actual application of the cursor switching system of the present invention and is not limited thereto. The operating unit 14 is operable to control the first electronic unit 12 and the second electronic unit 13 connected to the display unit 11. The cursor 141 has the first parameter setting in the first image. The first parameter setting could include parameters corresponding to a moving speed, a double-click speed, a scrolling direction, an acceleration, and a one-click locking operation of the cursor 141 in the first image. The second parameter setting could include parameters corresponding to the moving speed, the double-click speed, the scrolling direction, the acceleration, and the one-click locking operation of the cursor 141 in the second image. The parameter setting of the cursor 141 depends on the actual application of the cursor switching system of the present invention and is not limited thereto.

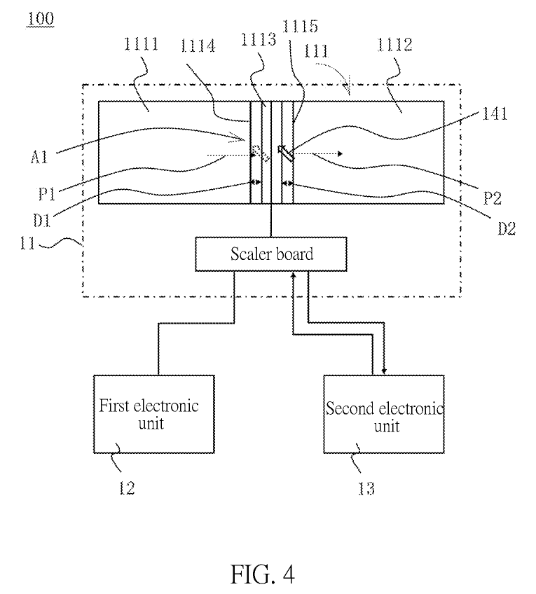

Please also refer to FIG. 4, which is a diagram of a cursor crossing a first switching line according to an embodiment of the present invention. The cursor switching system 100 further includes a first switching line 1114 and a second switching line 1115. The first switching line 1114 is located in the first display area 1111, and the second switching line 1115 is located in the second display area 1112. A distance from the first switching line 1114 to a nearest side of the switching area 1113 is a first distance D1, and a distance from the second switching line 1115 to a nearest side of the switching area 1113 is a second distance D2. When the cursor 141 crosses the first switching line 1114 until the cursor 141 at least partially contacts the switching area 1113 and then the cursor 141 stays in the switching area 1113 for a duration greater than or equal to the predetermined time before moving to the second display area 1112, the cursor 141 maintains the first parameter setting. In one embodiment, the predetermined time could be 1.5 seconds, and both the first distance D1 and the second distance D2 could be 10 pixels. In such a manner, the predetermined time and the switching range from the first switching line 1114 to the switching area 1113 can reserve a determined time for cursor-switching and ensure precise cursor-switching.

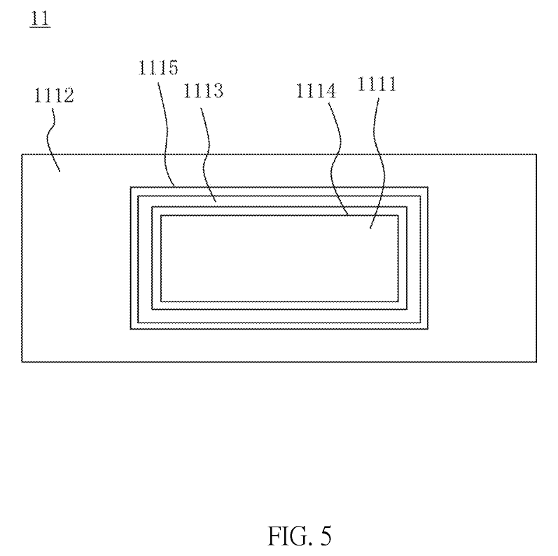

Please also refer to FIG. 5, which is a diagram of a display screen according to another embodiment of the present invention. The display unit 11 could be a monitor. The monitor has the display screen 111. The display screen 111 of the monitor includes the first display area 1111, the second display area 1112, and the switching area 1113. The switching area 1113 separates the first display area 1111 and the second display area 1112. As shown in FIGS. 2, 3 and 4, the first display area 1111 and the second display area 1112 are located on two sides of the switching area 1113 (i.e., PBP (Picture-by-Picture) mode). As shown in FIG. 5, the first display area 1111 is superimposed on the second display area 1112, and the switching area 1113 is located at an outer edge of the first display area 1111 (i.e., PIP (Picture-in-Picture) mode). In either PBP mode or PIP mode, the switching area 1113 separates the first display area 1111 and the second display area 1112 in the display screen 111. As for which mode is utilized, it depends on the actual application of the cursor switching system of the present invention and is not limited thereto.

In an embodiment of the present invention, a user moves the cursor 141 in the first display area 1111. When the cursor 141 moves from the first display area 1111 until the cursor 141 partially contacts the switching area 1113, the cursor 141 switches from the second parameter setting to the first parameter setting in the second image if the cursor 141 stays in the switching area 1113 for a duration greater than or equal to the predetermined time before moving to the second display area 1112. When the first electronic unit 12 and the second electronic unit 13 displays images with different resolutions, the prior art problem is that misaligned movement of the cursor 141 occurs if the cursor 141 moves from the first display area 1111 to the second display area 1112. When the parameter settings for the cursor 141 on the first electronic unit 12 and the second electronic unit 13 are different from each other, the parameters (e.g., the moving speed, the double-click speed, the scrolling direction, the acceleration, and the one-click lock operation of the cursor 141) of the cursor 141 moving from the first display area 1111 to the second display area 1112 are also different, causing an uncomfortable user experience. Via the design in which the switching area 1113 separates the first display area 1111 and the second display area 1112, the first parameter setting replaces the second parameter setting after the cursor 141 moves to the second image. This allows the cursor 141 to maintain the original parameter setting after moving from the first image to the second image, thereby avoiding misaligned movement of the cursor 141 from the first display area 1111 to the second display area 1112, as well as preventing an uncomfortable user experience regarding the moving speed, the double-click speed, the scrolling direction, the acceleration, or the one-click locking operation of the cursor 141.

In an embodiment of the present invention, after the user moves the cursor 141 from the first display area 1111 to the second display area 1112, the user then moves the cursor 141 in the second display area 1112. When the cursor 141 moves from the second display area 1112 until the cursor 141 partially contacts the switching area 1113, the cursor 141 maintains the first parameter setting if the cursor 141 stays in the switching area 1113 for a duration greater than or equal to the predetermined time before moving to the first display area 1111. As such, the present invention can ensure that the parameter setting of the cursor 141 can maintain consistent when the cursor 141 moves back and forth between the first display area 1111 and the second display area 1112, so as to avoid misaligned movement of the cursor 141 from the second display area 1112 to the first display area 1111, as well as prevent an uncomfortable user experience regarding the moving speed, the double-click speed, the scrolling direction, the acceleration, or the one-click locking operation of the cursor 141.

In an embodiment of the present invention, when the cursor 141 moves from the first display area 1111 until the cursor 141 at least partially contacts the switching area 1113, the cursor 141 is located at a coordinate A1 at this time. If the cursor 141 moves to the second display area 1112 after staying in the switching area 1113 for a duration less than the predetermined time, the cursor 141 retains the first parameter setting. In one embodiment, when the cursor 141 moves to the second display area 1112 after staying in the switching area 1113 for the duration less than the predetermined time, the cursor switching system 100 returns the cursor 141 to the coordinate A1, so as to prevent the user from inadvertently moving the cursor 141 from the first display area 1111 to the second display area 1112.

In an embodiment of the present invention, the cursor 141 moves from the first display area 1111 to the switching area 1113 with a first trajectory P1 and a first speed, the cursor 141 switches from the second parameter setting to the first parameter setting in the second image, and the cursor 141 maintains the first trajectory P1 and the first speed while moving from the switching area 1113 to the second display area 1112. In a specific implementation, the cursor 141 travels a predetermined distance relative to a side of the switching area 1113 from the first display area 1111 to the switching area 1113, the cursor 141 forms the first trajectory P1 within the predetermined distance, and a second trajectory P2 is collinear with the first trajectory P1 when the cursor 141 moves from the switching area 1113 to the second display area 1112 with the second trajectory P2. In such a manner, misalignment movement of the cursor 141 can be avoided when the cursor 141 moves from the first image with a first resolution in the first display area 1111 to the second image with a second resolution in the second display area 1112.

In an embodiment of the present invention, the cursor switching system 100 could further include a storage unit. The storage unit is coupled to the operating unit 14. The operating unit 14 controls the first electronic unit 12 to send the first parameter setting to the storage unit, and the operating unit 14 controls the second electronic unit 13 to send the second parameter setting to the storage unit. When the cursor 141 moves from the first display area 1111 until the cursor 141 at least partially contacts the switching area 1113, the first trajectory P1 and the first speed of the cursor 141 are stored in the storage unit, and the cursor 141 then moves from the switching area 1113 to the second display area 1112 with the first trajectory P1 and the first speed. In a specific implementation, the storage unit could be a scaler board, a monitor USB hub or an MCU (Micro Control Unit) built into the display unit 11. The storage unit could also be a keyboard or a mouse connected to the display unit 11 in a USB connection manner, such as a USB keyboard or a mouse connected to a USB port of the monitor. The storage unit could also be a memory provided in a port externally connected to the display unit 11. As for which type of storage unit is adopted, it depends on the actual application of the cursor switching system of the present invention and is not limited thereto. It is more preferable that the storage unit is a USB hub inside the monitor. Using the USB hub as a storage medium allows a faster exchange speed of the first parameter setting and the second parameter setting, meaning the speed of exchanging cursor coordinate information from the first electronic unit 12 to the second electronic unit 13 via the USB hub is faster than that via the scaler board. When software communicates with the scalar board via the DDC/CI (Display Data Channel/Control Interface) protocol using an I2C (Inter-Integrated Circuit) bus, the speed is only 100kbps. However, when the software communicates with the USB hub using HID (Human Interface Device) or Hub-Class devices, the speed of the USB hub is several times faster than that of the I2C bus. While the storage unit is a USB hub, besides being faster, the USB hub does not have the interference problem that the I2C bus can interfere with other software also using the I2C bus to communicate with the scalar board.

In an embodiment of the present invention, the first electronic unit 12 displays the first image in the first display area 1111, and the second electronic unit 13 displays the second image in the second display area 1112. It is assumed that an initial position of the cursor 141 is located in the first display area 1111 and the cursor 141 moves from the first display area 1111 to the switching area 1113 with the first trajectory P1 and the first speed. When the user operates the cursor 141 to move from the first display area 1111 until the cursor 141 at least partially contacts the switching area 1113 and then the cursor 141 stays in the switching area 1113 for at least the predetermined time, the user then moves the cursor 141 from the switching area 1113 to the second display area 1112. During the aforesaid process, the cursor 141 switches from the second parameter setting to the first parameter setting in the second image, and the cursor 141 maintains the first trajectory P1 and the first speed while moving from the switching area 1113 to the second display area 1112. That is, the second parameter setting of the cursor 141 in the second display area 1112 is replaced by the first parameter setting, so that the cursor 141 can have the same moving speed in the first display area 1111 and the second display area 1112 and can maintain the same movement trajectory across the switching area 1113. On the other hand, when the user operates the cursor 141 again to move from the second display area 1112 until the cursor 141 at least partially contacts the switching area 1113 and the cursor 141 stays in the switching area 1113 for a duration greater than or equal to the predetermined time, the cursor 141 then moves from the switching area 1113 to the first display area 1111 with the second trajectory and the second speed. During the aforesaid process, the cursor 141 maintains the first parameter setting, and the cursor 141 moves from the switching area 1113 to the first display area 1111 with the second trajectory and the first speed. When the user operates the cursor 141 to move from the first display area 1111 until the cursor 141 at least partially contacts the switching area 1113 and the cursor 141 is located at the coordinate A1 at this time, if the cursor 141 stays in the switching area 1113 for a duration less than the predetermined time and the cursor 141 then moves from the switching area 1113 to the second display area 1112, the cursor switching system 100 returns the cursor 141 to the coordinate A1, and the cursor 141 cannot enter the second display area 1112.

In an embodiment of the present invention, the first electronic unit 12 displays the first image in the first display area 1111, and the second electronic unit 13 displays the second image in the second display area 1112. It is assumed that the initial position of the cursor 141 is located in the first display area 1111, and the cursor 141 moves from the first display area 1111 with the first trajectory P1 and the first speed, crossing the first switching line 1114 to the switching area 1113. When the user operates the cursor 141 to move from the first display area 1111 across the first switching line 1114 until the cursor 141 at least partially contacts the switching area 1113 and the cursor 141 stays in the switching area 1113 for a duration greater than or equal to the predetermined time, the cursor switching system 100 controls the cursor 141 to move from the switching area 1113 to the second display area 1112, and the cursor 141 switches from the second parameter setting to the first parameter setting in the second image. During the aforesaid process, the cursor 141 moves in the second display area 1112 with the first trajectory P1 and the first speed. That is, the second parameter setting of the cursor 141 in the second display area 1112 is replaced by the first parameter setting, so that the cursor 141 can have the same moving speed in the first display area 1111 and the second display area 1112 and maintains the same movement trajectory across the switching area 1113. On the other hand, when the user operates the cursor 141 again to move from the second display area 1112 with the second trajectory and the second speed across the second switching line 1115 until the cursor 141 at least partially contacts the switching area 1113 and the cursor 141 stays in the switching area 1113 for a duration greater than or equal to the predetermined time, the cursor switching system 100 controls the cursor 141 to move from the switching area 1113 to the first display area 1111, the cursor 141 maintains the first parameter setting, and the cursor 141 moves in the first display area 1111 with the second trajectory and the second speed. The second switching line 1115 is located in the second display area 1112, and a distance from the second switching line 1115 to a side of the switching area 1113 is the second distance D2, wherein the second distance D2 is 10 pixels. When the user operates the cursor 141 to move from the first display area 1111 across the first switching line 1114 until the cursor 141 at least partially contacts the switching area 1113 and the cursor 141 is at the coordinate A1 at this time, if the cursor 141 stays in the switching area 1113 for a duration less than the predetermined time and the cursor 141 then moves from the switching area 1113 to the second display area 1112, the cursor switching system 100 returns the cursor 141 to the coordinate A1, meaning that the cursor 141 cannot enter the second display area 1112, and the cursor switching system 100 recalculates the staying time of the cursor 141.

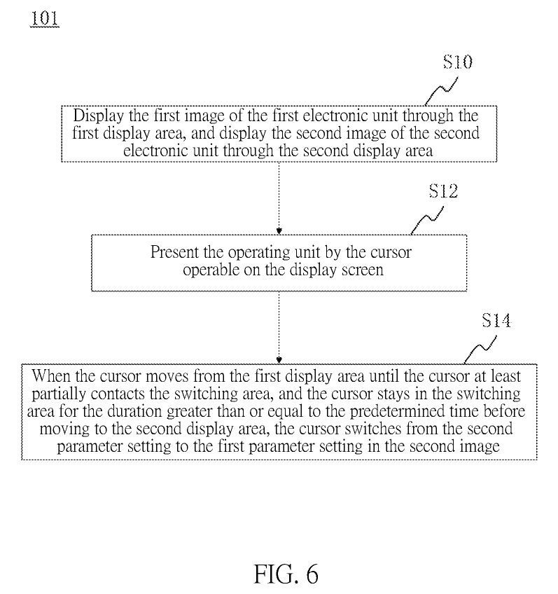

Referring also to FIG. 6, which is a flowchart of a cursor switching method according to an embodiment of the present invention. The present invention provides a cursor switching method 101 applied to the cursor switching system 100 for switching a cursor between display areas. The cursor switching system 100 includes the display unit 11, the first electronic unit 12, the second electronic unit 13, and the operating unit 14. The display unit 11 is respectively coupled to the first electronic unit 12, the second electronic unit 13, and the operating unit 14. The display unit 11 has the display screen 111. The display screen 111 includes the first display area 1111, the second display area 1112, and the switching area 1113. The switching area 1113 separates the first display area 1111 and the second display area 1112. The cursor switching method 101 includes the following steps. First, in step S10, display the first image of the first electronic unit 12 through the first display area 1111, and display the second image of the second electronic unit 13 through the second display area 1112. Next, in step S12, present the operating unit 14 by the cursor 141 on the display screen 111, wherein the cursor 141 is operable on the display screen 111. In step S14, when the cursor 141 moves from the first display area 1111 until the cursor 141 at least partially contacts the switching area 1113, and the cursor 141 stays in the switching area 1113 for a duration greater than or equal to the predetermined time before moving to the second display area 1112, the cursor 141 switches from the second parameter setting to the first parameter setting in the second image. The cursor 141 has the first parameter setting in the first image, and the cursor 141 has the second parameter setting in the second image, wherein the first parameter setting is different from the second parameter setting. In such a manner, consistent speed and behavior of the cursor when moving between different display areas can be achieved by monitoring whether the cursor moves to and stays in the switching area for cursor parameter switching.

In a preferred embodiment, when the cursor 141 crosses the first switching line 1114 until the cursor 141 at least partially contacts the switching area 1113, and the cursor 141 stays in the switching area 1113 for a duration greater than or equal to the predetermined time before moving to the second display area 1112, the cursor 141 maintains the first parameter setting. The first switching line 1114 is located in the first display area 1111, and the second switching line 1115 is located in the second display area 1112. The distance from the first switching line 1114 to the nearest side of the switching area 1113 is the first distance D1, and the distance from the second switching line 1115 to the nearest side of the switching area 1113 is the second distance D2. In a specific implementation, the predetermined time is 1.5 seconds, and both the first distance D1 and the second distance D2 are 10 pixels. In this way, the predetermined time and the range from the first switching line 1114/second switching line 1115 to the switching area 1113 reserve the determined time for cursor parameter switching and ensure accurate determination for cursor movement.

In a preferred embodiment, when the cursor 141 moves from the first display area 1111 until the cursor 141 at least partially contacts the switching area 1113, the cursor 141 is located at the coordinate A1 at this time. If the cursor 141 moves to the second display area 1112 after staying in the switching area 1113 for a duration less than the predetermined time, the cursor 141 retains the first parameter setting. In a specific implementation, when the cursor 141 moves to the second display area 1112 after staying in the switching area 1113 for a duration less than the predetermined time, the cursor switching system 100 returns the cursor 141 to the coordinate A1, thereby preventing the user from inadvertently moving the cursor 141 from the first display area 1111 to the second display area 1112.

In a preferred embodiment, the cursor 141 moves from the first display area 1111 to the switching area 1113 with the first trajectory P1 and the first speed, the cursor 141 switches from the first parameter setting to the second parameter setting, and the cursor 141 then moves from the switching area 1113 to the second display area 1112 with the first trajectory P1 and the first speed. Specifically, the cursor 141 travels a predetermined distance from the first display area 1111 to the switching area 1113 across the side of the switching area 1113. Within this predetermined distance, the cursor 141 forms the first trajectory P1. When the cursor 141 moves from the switching area 1113 to the second display area 1112 with the second trajectory, the second trajectory is collinear with the first trajectory P1, so as to prevent misalignment movement of the cursor 141 during the movement of the cursor 141 from the first image with the first resolution in the first display area 1111 to the second image with the second resolution in the second display area 1112.

In a preferred embodiment, the cursor switching system 100 could further include the storage unit. The storage unit is coupled to the operating unit 14. The operating unit 14 controls the first electronic unit 12 to send the first parameter setting to the storage unit, and the operating unit 14 controls the second electronic unit 13 to send the second parameter setting to the storage unit. When the cursor 141 moves from the first display area 1111 until the cursor 141 at least partially contacts the switching area 1113, the first trajectory P1 and the first speed of the cursor 141 are stored in the storage unit, and the cursor 141 then moves from the switching area 1113 to the second display area 1112 with the first trajectory P1 and the first speed. In a specific implementation, the storage unit could be provided in the display unit 11, or could be provided in a port externally connected to the display unit 11. As for which type of storage unit is adopted, it depends on the actual application of the present invention and is not limited thereto.

In a preferred embodiment, the first electronic unit 12 displays the first image in the first display area 1111, and the second electronic unit 13 displays the second image in the second display area 1112. It is assumed that the initial position of the cursor 141 is located in the first display area 1111. The cursor 141 moves from the first display area 1111 to the switching area 1113 with the first trajectory P1 and the first speed. When the user operates the cursor 141 to move from the first display area 1111 until the cursor 141 at least partially contacts the switching area 1113 and the cursor 141 stays in the switching area 1113 for at least the predetermined time, the cursor 141 then moves from the switching area 1113 to the second display area 1112. During the aforesaid process, the cursor 141 switches from the second parameter setting to the first parameter setting in the second image, and the cursor 141 maintains the first trajectory P1 and the first speed while moving from the switching area 1113 to the second display area 1112. That is, the second parameter setting of the cursor 141 in the second display area 1112 is replaced by the first parameter setting, so that the cursor 141 has the same moving speed in the first display area 1111 and the second display area 1112 and maintains the same movement trajectory across the switching area 1113. On the other hand, when the user operates the cursor 141 again to move from the second display area 1112 until the cursor 141 at least partially contacts the switching area 1113 and the cursor 141 stays in the switching area 1113 for a duration greater than or equal to the predetermined time, the cursor 141 then moves from the switching area 1113 to the first display area 1111 with the second trajectory and the second speed. During the aforesaid process, the cursor 141 maintains the first parameter setting, and the cursor 141 moves from the switching area 1113 to the first display area 1111 with the second trajectory and the first speed. When the user operates the cursor 141 to move from the first display area 1111 until the cursor 141 at least partially contacts the switching area 1113 and the cursor 141 is at the coordinate A1 at this time, if the cursor 141 stays in the switching area 1113 for a duration less than the predetermined time and the cursor 141 then moves from the switching area 1113 to the second display area 1112, the cursor switching system 100 returns the cursor 141 to the coordinate A1, and the cursor 141 cannot enter the second display area 1112.

In a preferred embodiment, the first electronic unit 12 displays the first image in the first display area 1111, and the second electronic unit 13 displays the second image in the second display area 1112. It is assumed that the initial position of the cursor 141 is located in the first display area 1111. The cursor 141 moves from the first display area 1111 with the first trajectory P1 and the first speed to the switching area 1113 across the first switching line 1114. When the user operates the cursor 141 to move from the first display area 1111 across the first switching line 1114 until the cursor 141 at least partially contacts the switching area 1113 and the cursor 141 stays in the switching area 1113 for a duration greater than or equal to the predetermined time, the cursor switching system 100 controls the cursor 141 to move from the switching area 1113 to the second display area 1112, wherein the cursor 141 switches from the second parameter setting to the first parameter setting in the second image, and the cursor 141 moves in the second display area 1112 with the first trajectory P1 and the first speed. That is, the second parameter setting of the cursor 141 in the second display area 1112 is replaced by the first parameter setting, so that the cursor 141 has the same moving speed in the first display area 1111 and the second display area 1112 and maintains the same movement trajectory across the switching area 1113. On the other hand, when the user operates the cursor 141 again to move from the second display area 1112 with the second trajectory and the second speed across the second switching line 1115 until the cursor 141 at least partially contacts the switching area 1113 and the cursor 141 stays in the switching area 1113 for a duration greater than or equal to the predetermined time, the cursor switching system 100 controls the cursor 141 to move from the switching area 1113 to the first display area 1111, wherein the cursor 141 maintains the first parameter setting, and the cursor 141 moves in the first display area 1111 with the second trajectory and the second speed. The second switching line 1115 is located in the second display area 1112, and the distance from the second switching line 1115 to the side of the switching area 1113 is the second distance D2, wherein the second distance D2 is 10 pixels. When the user operates the cursor 141 to move from the first display area 1111 across the first switching line 1114 until the cursor 141 at least partially contacts the switching area 1113 and the cursor 141 is at the coordinate A1 at this time, if the cursor 141 stays in the switching area 1113 for a duration less than the predetermined time and the cursor 141 then moves from the switching area 1113 to the second display area 1112, the cursor switching system 100 returns the cursor 141 to the coordinate A1, the cursor 141 cannot enter the second display area 1112, and the cursor switching system 100 recalculates the staying time of the cursor 141.

In summary, the present invention provides the cursor switching system and the cursor switching method thereof. The cursor switching system includes the display unit, the first electronic unit, the second electronic unit, and the operating unit. The display unit has the display screen, and the display screen includes the first display area, the second display area, and the switching area. The switching area separates the first display area and the second display area. The first electronic unit is coupled to the display unit, and the first electronic unit displays the first image in the first display area. The second electronic unit is coupled to the display unit, and the second electronic unit displays the second image in the second display area. The operating unit is coupled to the display unit, and the operating unit is presented by the cursor on the display screen. The cursor is operable on the display screen. The cursor has the first parameter setting in the first image, and the cursor has the second parameter setting in the second image, wherein the first parameter setting is different from the second parameter setting. When the cursor moves from the first display area until the cursor at least partially contacts the switching area, and the cursor stays in the switching area for the predetermined time before moving to the second display area, the cursor switches from the first parameter setting to the second parameter setting. In such a manner, consistent speed and behavior of the cursor when moving between different display areas can be achieved by monitoring whether the cursor moves to and stays in the switching area for cursor parameter switching.

Although the present invention has been described with reference to the accompanying drawings, the embodiments disclosed in the drawings are intended to be illustrative of preferred embodiments of the present invention and are not to be construed as limiting the present invention. The proportions in the schematic drawings do not represent the actual proportional relationships of the components for the sake of clarity of description of the required components.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A cursor switching system comprising:
a display unit having a display screen, wherein the display screen comprises a first display area, a second display area, and a switching area, and the switching area separates the first display area and the second display area;
a first electronic unit coupled to the display unit, wherein the first electronic unit displays a first image in the first display area;
a second electronic unit coupled to the display unit, wherein the second electronic unit displays a second image in the second display area; and
an operating unit coupled to the display unit, wherein the operating unit is presented by a cursor on the display screen, and the cursor is operable on the display screen;
wherein the cursor has a first parameter setting in the first image, the cursor has a second parameter setting in the second image, and the first parameter setting is different from the second parameter setting; when the cursor moves from the first display area until the cursor at least partially contacts the switching area and then the cursor stays in the switching area for a duration greater than or equal to a predetermined time before moving to the second display area, the cursor switches from the second parameter setting to the first parameter setting in the second image to be operated according to the first parameter setting.

2. The cursor switching system of claim 1, wherein the display screen further comprises a first switching line located in the first display area, and a distance from the first switching line to a side of the switching area is a first distance; when the cursor crosses the first switching line until the cursor at least partially contacts the switching area and then the cursor stays in the switching area for the duration greater than or equal to the predetermined time before moving to the second display area, the cursor maintains the first parameter setting.

3. The cursor switching system of claim 2, wherein the predetermined time is 1.5 seconds, and the first distance is 10 pixels.

4. The cursor switching system of claim 1, wherein the cursor moves from the first display area to the switching area with a first trajectory and a first speed, and when the cursor switches from the first parameter setting to the second parameter setting, the cursor moves from the switching area to the second display area with the first trajectory and the first speed.

5. The cursor switching system of claim 4, wherein the cursor switching system further comprises a storage unit coupled to the operating unit, the operating unit controls the first electronic unit to send the first parameter setting to the storage unit, and the operating unit controls the second electronic unit to send the second parameter setting to the storage unit; when the cursor moves from the first display area until the cursor at least partially contacts the switching area, the first trajectory and the first speed of the cursor are stored in the storage unit, and the cursor then moves from the switching area to the second display area with the first trajectory and the first speed.

6. The cursor switching system of claim 5, wherein the storage unit is a USB hub.

7. A cursor switching method applied to a cursor switching system, the cursor switching system comprising a display unit, a first electronic unit, a second electronic unit, and an operating unit, the display unit being respectively coupled to the first electronic unit, the second electronic unit, and the operating unit, the display unit having a display screen comprising a first display area, a second display area, and a switching area, the switching area separating the first display area and the second display area, and the cursor switching method comprising:
displaying a first image of the first electronic unit in the first display area, and displaying a second image of the second electronic unit in the second display area;
presenting the operating unit by a cursor on the display screen, wherein the cursor is operable on the display screen; and
switching the cursor from a second parameter setting to a first parameter setting in the second image when the cursor moves from the first display area until the cursor at least partially contacts the switching area and then the cursor stays in the switching area for a duration greater than or equal to a predetermined time before moving to the second display area, wherein the cursor has the first parameter setting in the first image, the cursor has the second parameter setting in the second image, and the first parameter setting is different from the second parameter setting.

8. The cursor switching method of claim 7, wherein the display screen further comprises a first switching line located in the first display area, and a distance from the first switching line to a side of the switching area is a first distance; when the cursor crosses the first switching line until the cursor at least partially contacts the switching area and then the cursor stays in the switching area for the duration greater than or equal to the predetermined time before moving to the second display area, the cursor maintains the first parameter setting.

9. The cursor switching method of claim 7, wherein when the cursor moves from the first display area until the cursor at least partially contacts the switching area and then the cursor stays in the switching area for a duration less than the predetermined time before moving to the second display area, the cursor retains the first parameter setting.

10. The cursor switching method of claim 7, wherein the cursor moves from the first display area to the switching area with a first trajectory and a first speed, and when the cursor switches from the first parameter setting to the second parameter setting, the cursor moves from the switching area to the second display area with the first trajectory and the first speed.

11. The cursor switching method of claim 10, wherein the cursor switching system further comprises a storage unit, and the cursor switching method further comprises:
coupling the storage unit to the operating unit;
controlling the first electronic unit to send the first parameter setting to the storage unit via the operating unit;
controlling the second electronic unit to send the second parameter setting to the storage unit via the operating unit;
storing the first trajectory and the first speed of the cursor in the storage unit when the cursor moves from the first display area until the cursor at least partially contacts the switching area; and
moving the cursor with the first trajectory and the first speed when the cursor moves from the switching area to the second display area.
